(19) United States
(12) Patent Application Publication
(10) Pub. No.: US 2025/0392754 A1
(43) Pub. Date: Dec. 25, 2025

(54) VIDEO ENCODING/DECODING METHOD AND APPARATUS

(71) Applicant: INDUSTRY ACADEMY COOPERATION FOUNDATION OF SEJONG UNIVERSITY, Seoul (KR)

(72) Inventors: Yung-Lyul LEE, Seoul (KR); Myung Jun KIM, Guri-si, Gyeonggi-do (KR); Su Yeon LIM, Namyangju-si, Gyeonggi-do (KR); Hyeon Ju SONG, Seoul (KR); Min Kyeong CHOI, Bycheon-si, Gyeonggi-do (KR)

(21) Appl. No.: 18/834,217

(22) PCT Filed: Jan. 27, 2023
(86) PCT No.: PCT/KR2023/001302

§ 371 Date: Apr. 10, 2025

(30) Foreign Application Priority Data
Jan. 27, 2022 (KR) 10-2022-0012631
Feb. 17, 2022 (KR) 10-2022-0021078
Jun. 16, 2022 (KR) 10-2022-0073743
Jan. 27, 2023 (KR) 10-2023-0011080

(51) Int. Cl. H04N 19/60; H04N 19/12; H04N 19/176; H04N 19/18

(52) U.S. Cl. CPC H04N 19/60; H04N 19/12; H04N 19/176; H04N 19/18

(57) ABSTRACT

The present disclosure provides a video decoding method including: acquiring the number of non-zero coefficients of a dequantized block; determining an inverse transform method of the dequantized block according to the number of non-zero coefficients; and performing an inverse transform of the dequantized block according to the determined inverse transform method.

### TECHNICAL FIELD

The present invention relates to an image encoding/decoding method and apparatus, and more particularly, to an image encoding/decoding method and apparatus that perform an inverse transform using linearity.

### BACKGROUND ART

Recently, various applications show increasing demand for high-definition and high-quality images such as a high-definition (HD) image and an ultra high-definition (UHD) image. As image data has a higher resolution and higher quality, the amount of data increases as compared to existing image data, and transmission cost and storage cost increase when the image data is transmitted using a medium such as an existing wired or wireless broadband line or is stored using an existing storage medium. These problems occur because image data has a higher resolution and higher quality, and high efficiency image compression technologies may be utilized to solve the problems.

There are various image compression technologies such as an inter prediction technology that predicts a pixel value included in a current picture from a picture before or after the current picture, an intra prediction technology that predicts a pixel value included in a current picture by using pixel information in the current picture, and an entropy coding technology that allocates a short code to a value with a high appearance frequency and allocates a long code to a value with a low appearance frequency, and these image compression technologies may be used to effectively compress, transmit or store image data.

Meanwhile, with increasing demand for high-resolution images, the demand for stereoscopic image contents as a new image service is also on the rise. The video compression technology for effectively providing high-resolution and ultra high-resolution stereoscopic image contents is under discussion.

### DISCLOSURE

### Technical Problem

The present disclosure is directed to providing an image encoding/decoding method and apparatus that perform an inverse transform using linearity.

In addition, the present invention is directed to providing a recording medium for storing a bitstream that is generated by an image encoding method or apparatus.

The technical problems solved by the present invention are not limited to the above technical problems and other technical problems which are not described herein will be clearly understood by a person having ordinary skill in the technical field, to which the present invention belongs, from the following description.

### Technical Solution

In the present disclosure, a video decoding method is provided including acquiring the number of non-zero coefficients of a dequantized block; determining an inverse transform method of the dequantized block according to the number of non-zero coefficients; and performing an inverse transform of the dequantized block according to the determined inverse transform method.

According to an embodiment, the determining of the inverse transform method of the dequantized block may include: comparing the number of the non-zero coefficients and a predetermined threshold value; and determining the inverse transform method of the dequantized block based on a result of the comparison.

According to an embodiment, the determining of the inverse transform method of the dequantized block may include: determining the number of multiplying operations required for a linear inverse transform from the number of the non-zero coefficients; comparing the number of the multiplying operations and a predetermined threshold value; and determining the inverse transform method of the dequantized block based on a result of the comparison.

According to an embodiment, the number of the multiplying operations may be determined based on the number of the non-zero coefficients and a size of the dequantized block.

According to an embodiment, the predetermined threshold value may be determined based on the size of the dequantized block.

According to an embodiment, the video decoding method may further include determining a vertical kernel and a horizontal kernel that are applied to the dequantized block, and the predetermined threshold value may be determined based on the vertical kernel, the horizontal kernel, and the size of the dequantized block.

According to an embodiment, the vertical kernel and the horizontal kernel may be determined from at least one of a DCT-II transform, a DST-VII transform, and a DCT-VIII transform.

According to an embodiment, the vertical kernel and the horizontal kernel may be determined based on the size of the dequantized block and a prediction method that is applied to the dequantized block.

According to an embodiment, based on a picture type of the dequantized block, the inverse transform method of the dequantized block may be determined.

According to an embodiment, the determining of the inverse transform method of the dequantized block may include determining, according to the number of the non-zero coefficients, whether or not a linear inverse transform is applied to the dequantized block, when the picture type of the dequantized block is an all intra (AI) type or a random access (RA) type.

According to an embodiment, the determining of the inverse transform method of the dequantized block may determine that the linear inverse transform is not applied to the dequantized block, when the picture type of the dequantized block is not the AI type or the RA type.

According to an embodiment, based on a quantization parameter that is applied to dequantization of the dequantized block, the inverse transform method of the dequantized block may be determined.

According to an embodiment, the determining of whether or not the linear inverse transform is applied to the dequantized block according to the number of the non-zero coefficients may be included when the quantization parameter is greater than a threshold quantization parameter value.

According to an embodiment, when the quantization parameter is smaller than the threshold quantization parameter value, it may be determined that the linear inverse transform is not applied to the dequantized block.

According to an embodiment, the video decoding method may further include acquiring, from a parameter set, linear inverse transform permission information indicating whether or not a linear inverse transform is permitted, and the determining of the inverse transform method of the dequantized block may determine whether or not the inverse transform method of the dequantized block is a linear inverse transform method, when the linear inverse transform permission information indicates that the linear inverse transform is permitted.

According to an embodiment, the parameter set may be at least one of a video parameter set, a sequence parameter set, a picture parameter set, and an adaptation parameter set.

According to an embodiment, based on a color component of the dequantized block, the inverse transform method of the dequantized block may be determined.

According to an embodiment, according to the determined inverse transform method, the performing of the inverse transform of the dequantized block may include: when the inverse transform method is a linear inverse transform method, partitioning the dequantized block into a plurality of sub-blocks that include only one non-zero coefficient and a remaining coefficient as a zero coefficient; performing an inverse transform for each of the plurality of sub-blocks; and acquiring an inverse-transformed block of the dequantized block based on each of a plurality of inverse-transformed element blocks.

In the present disclosure, a video encoding method is provided including encoding a block and dequantizing the encoded block; acquiring the number of non-zero coefficients of the dequantized block; determining an inverse transform method of the dequantized block according to the number of non-zero coefficients; performing an inverse transform of the dequantized block according to the determined inverse transform method; and reconstructing a block by using the dequantized block and encoding another block based on the reconstructed block.

The present disclosure may provide a computer-readable recording medium storing a bitstream for an encoded video, the computer-readable recording medium includes the bitstream that is generated by a video encoding method, and the method may include: encoding a block and dequantizing the encoded block; acquiring the number of non-zero coefficients of the dequantized block; determining an inverse transform method of the dequantized block according to the number of non-zero coefficients; performing an inverse transform of the dequantized block according to the determined inverse transform method; and reconstructing a block by using the dequantized block and encoding another block based on the reconstructed block.

### Advantageous Effects

According to the present disclosure, an image encoding/decoding method and apparatus that perform an inverse transform using linearity may be provided.

In addition, according to the present invention, a method and apparatus for transmitting or storing a bitstream generated by an image encoding method/apparatus according to the present invention may be provided.

In addition, according to the present invention, a computer-readable recording medium may be provided for a bitstream generated by an image encoding method/apparatus according to the present invention.

In addition, image data may be efficiently encoded and decoded by an image encoding method/apparatus according to the present invention.

### DESCRIPTION OF THE DRAWINGS

FIG. 1 is a schematic diagram showing the configuration of an image encoding apparatus.

FIG. 2 is a diagram illustrating an embodiment of a prediction unit of an image encoding apparatus.

FIG. 3 shows an example of showing a block into sub-blocks that are constructed with one non-zero coefficient respectively.

FIG. 4 shows an embodiment of an inverse transform method that permits an inverse transform using separable linearity.

FIG. 5 shows a scan method that rearranges coefficients of a dequantized block into a one-dimensional vector.

FIG. 6 shows an example of rearrangement of coefficients in a 4×4 block into a one-dimensional vector using horizontal scan.

FIG. 7 shows an example of separating a one-dimensional vector into sub-vectors.

FIG. 8 shows an example of performing an inverse transform for each sub-vector.

FIG. 9 provides an embodiment of a video decoding method that can use a linear inverse transform method.

FIG. 10 provides an embodiment of a video encoding method that can use a linear inverse transform method.

FIG. 11 shows magnitude responses of a 4-tap DCT interpolation filter and an 8-tap DST interpolation filter in a 16/32-pixel position.

FIG. 12 shows an embodiment of a coefficient of an 8-tap DST interpolation filter.

FIG. 13 shows magnitude responses of a 4-tap DCT interpolation filter, a 4-tap Gaussian interpolation filter, an 8-tap DCT interpolation filter, and an 8-tap Gaussian interpolation filter in a 16/32-pixel position.

FIG. 14 shows an embodiment of a method for selecting an interpolation filter by using frequency information.

FIG. 15 and FIG. 16 each show a coefficient of an 8-tap DCT interpolation filter and an embodiment of an 8-tap smoothing interpolation filter.

FIG. 17 shows an embodiment of an interpolation filter that is selected according to a boundary correlation threshold.

### BEST MODE FOR INVENTION

In the present disclosure, a video decoding method is provided including acquiring the number of non-zero coefficients of a dequantized block; determining an inverse transform method of the dequantized block according to the number of non-zero coefficients; and performing an inverse transform of the dequantized block according to the determined inverse transform method.

### DETAILED DESCRIPTION OF THE INVENTION

Hereinafter, exemplary embodiments of the present invention will be described in detail with reference to the accompanying drawings so that those skilled in the art may easily implement the present invention. However, the present invention may be implemented in various different ways, and is not limited to the embodiments described therein. In the drawings, parts irrelevant to the description are omitted in order to clearly describe the present invention, and similar reference numerals are assigned to similar parts throughout the specification.

Throughout this specification, when a certain part is “connected” with another part, this includes not only a case in which the certain part is directly connected to another part but also a case in which the certain part is electrically connected with another element with the other part interposed therebetween.

In addition, when a part of the present specification “includes” a certain component, it means that other components may be further included, rather than excluding other components, unless otherwise stated.

In addition, terms ‘first’, ‘second’, etc. may be used to describe various components, but the components are not to be construed as being limited to the terms. The terms are only used to differentiate one component from other components.

In addition, in the embodiments of the apparatus and method described in the present specification, some of the components of the apparatus or some of the steps of the method may be omitted. In addition, the order of some of the components of the apparatus or some of the steps of the method may be changed. In addition, other components or other steps may be inserted into some of the components of the apparatus or some of the steps of the method.

In addition, some components or some steps of the first embodiment of the present invention may be added to the second embodiment of the present invention or may replace some components or some steps of the second embodiment.

In addition, components shown in the embodiments of the present invention are independently shown to represent different characteristic functions, and it does not mean that each component is formed of separate hardware or a single software component. That is, each component is described by being listed as a respective component for convenience of description, and at least two of the components are combined to form one component, or one component may be divided into a plurality of components to perform a function. Integrated embodiments and separate embodiments of each of these components are also included in the scope of the present invention without departing from the essence of the present invention.

First, the terms used in this application will be briefly described.

A video decoding apparatus which will be described below may be included in a private security camera, a private security system, a military security camera, a military security system, a personal computer (PC), a laptop, a portable multimedia player (PMP), a wireless communication terminal, a smartphone, and a server terminal such as a TV application server and a service server, and may mean various apparatuses each including a user terminal such as various types of apparatuses, a communication device such as a communication modem for performing communication through a wired/wireless communication network, a memory for storing various types of programs and data for image decoding or inter or intra prediction for decoding, a microprocessor for performing operation and control by executing a program, etc.

In addition, an image encoded into a bitstream by an encoder may be transmitted to an image decoding apparatus via a wired/wireless communication network such as the Internet, a short-range wireless communication network, a wireless LAN network, a WiBro network or a mobile communication network or via various communication interfaces such as a cable or a universal serial bus (USB), decoded, reconstructed and reproduced as an image in real time or non-real-time. Alternatively, the bitstream generated by the encoder may be stored in the memory. The memory may include both a volatile memory and a nonvolatile memory. In this specification, the memory may be expressed as a recording medium storing a bitstream.

In general, a video may be composed of a series of pictures, and each picture may be divided into a coding unit such as a block. In addition, it will be understood by those of ordinary skill in the technical field, to which the present embodiment belongs, that the term picture described below may be replaced with other terms having an equivalent meaning such as an image and a frame. In addition, it will be understood by those of ordinary skill in the art that the term “coding unit” may be substituted with other terms having an equivalent meaning such as a unit block and a block.

Hereinafter, the embodiment of the present invention will be described in greater detail with reference to the accompanying drawings. In describing the present invention, a repeated description of the same component will be omitted.

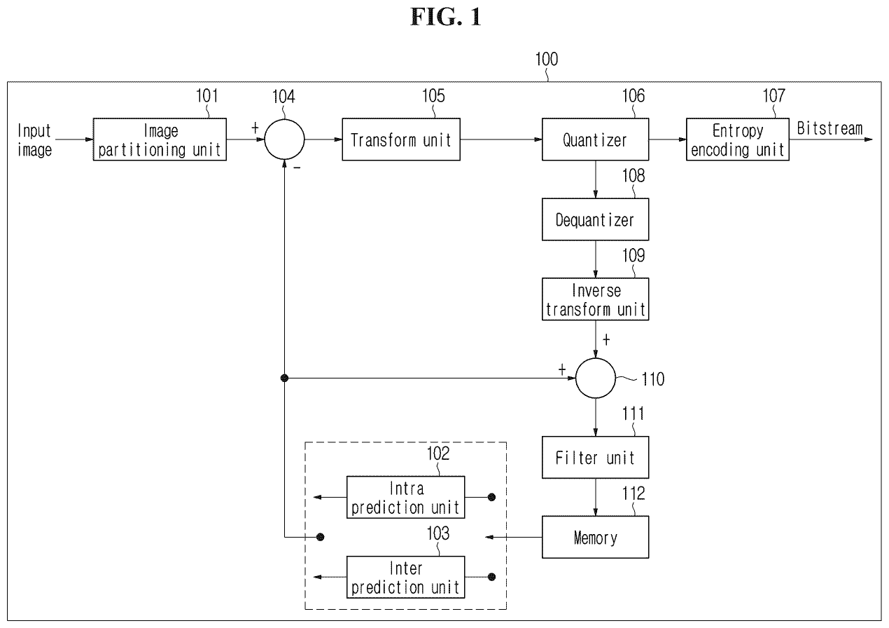

FIG. 1 is a schematic diagram showing the configuration of an image encoding apparatus.

An image encoding apparatus 100 may include an image partitioning unit 101, an intra prediction unit 102, an inter prediction unit 103, a subtractor 104, a transform unit 105, a quantizer 106, an entropy encoding unit 107, a dequantizer 108, an inverse transform unit 109, an adder 110, a filter unit 111, and a memory 112.

Rate distortion rates (RD-Costs) may be compared to select optimal information in each apparatus. RD-Cost means a cost value that is calculated using extortion information between an original block and a reconstructed block and a bit rate that is generated when a prediction mode is transmitted. Herein, a sum of absolute difference (SAD), a sum of absolute transformed difference (SATD), a sum of square for error (SSE) and the like may be used to calculate the cost value.

Constitutional parts shown in FIG. 1 are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

The image partitioning unit 100 may divide an input image into at least one block. Herein, the input image may have various types and sizes such as a picture, a slice, a tile, and a segment. A block may mean a coding unit (CU), a prediction unit (PU), or a transform unit (TU). The partitioning may be performed on the basis of at least one of a quadtree, a binary tree, and a ternary tree. The quadtree is a method of splitting a parent block into child blocks that are half of the parent block in width and height. The binary tree is a method of splitting a parent block into child blocks either width or height of which is half of the parent block. The ternary tree is a method of splitting a parent block into three child blocks with respect of either width or height. Through the binary tree or ternary tree-based partitioning described above, the block may have a type of a square as well as a non-square.

The prediction units 102 and 103 may include the inter prediction unit 103 for performing inter prediction and the intra prediction unit 102 for performing intra prediction. It is possible to determine whether inter prediction or intra prediction is to be performed for the prediction unit, and to determine specific information (e.g., intra prediction mode, motion vector, reference picture, etc.) according to each prediction method. Herein, a processing unit on which prediction is performed may be different from a processing unit for which a prediction method and specific information thereon are determined. For example, a prediction method and a prediction mode may be determined for each PU, while prediction may be performed for each TU.

A residual value (residual block) between a generated prediction block and an original block may be input to the transform unit 105. In addition, prediction mode information, motion vector information and the like, which are used for prediction, may be encoded along with the residual value by the entropy encoding unit 107 and be delivered to a decoder. When a specific encoding mode is used, a prediction block is not generated through the prediction units 102 and 103, but the original block may be encoded as it is and then transmitted to the decoding unit.

The intra prediction unit 102 may generate a prediction block on the basis of information on a reference pixel around a current block, which is pixel information within a current picture. When the prediction mode of a neighboring block of a current block on which intra prediction is to be performed is inter prediction, a reference pixel included in the neighboring block to which inter prediction is applied may be replaced with a reference pixel in another neighboring block to which intra prediction is applied. That is, when a reference pixel is not available, information on the unavailable reference pixel may be replaced with information on at least one reference pixel of the available reference pixels.

In intra prediction, a prediction mode may have a directional prediction mode, in which reference pixel information is used according to a prediction direction, and a non-directional mode that does not use directional information. A mode for predicting luma information and a mode for predicting chroma information may be different from each other. Intra prediction mode information or predicted luma signal information used for predicting luma information may be used to predict chroma information.

The intra prediction unit 102 may include an adaptive intra smoothing (AIS) filter, a reference pixel interpolation unit, and a DC filter. The AIS filter is a filter that performs filtering on a reference pixel of a current block and may adaptively determine whether or not to apply the filter according to a prediction mode of a current PU. When a prediction mode of a current block is a mode that does not perform AIS filtering, the AIS filter may not be applied.

When an intra prediction mode of a PU is a mode of performing intra prediction on the basis of a pixel value obtained by interpolating a reference pixel, the reference pixel interpolation unit of the intra prediction unit 102 may generate a reference pixel in a fraction unit position by interpolating a reference pixel. When a prediction mode of a current PU is a prediction mode of generating a prediction block without interpolating reference pixels, the reference pixels may not be interpolated. The DC filter may generate a prediction block through filtering, when a prediction mode of a current block is the DC mode.

The inter prediction unit 103 generates a prediction block by using a pre-reconstructed reference image stored in the memory 112 and motion information. For example, the motion information may include a motion vector, a reference picture index, a list 1 prediction flag, a list 0 prediction flag and the like.

A residual block, which includes a prediction unit (PU) generated from the prediction units 102 and 103 and information on a residual value, that is, a difference value between the PU and an original block, may be generated. The generated residual block may be input into the transform unit 105 and be transformed.

The inter prediction unit 103 may derive a prediction block based on information on at least one picture of a previous picture and a following picture of a current picture. In addition, a prediction block of a current block may be derived based on information on a completely encoded partial region within a current picture. The inter prediction unit 103 according to an embodiment of the present invention may include a reference picture interpolation unit, a motion prediction unit, and a motion compensation unit.

The reference picture interpolation unit may be provided with reference picture information from the memory 112 and generate pixel information less than an integer pixel from a reference picture. In the case of a luma pixel, a DCT-based 8-tap interpolation filter with a variable filter coefficient may be used to generate information on a pixel smaller than an integer pixel in a unit of a ¼ pixel. In the case of a chroma pixel, a DCT-based 4-tap interpolation filter with a variable filter coefficient may be used to generate information on a pixel smaller than an integer pixel in a unit of a ⅛ pixel.

The motion prediction unit may perform motion prediction on the basis of a reference picture interpolated by the reference picture interpolation unit. Various methods, such as a full search-based block matching algorithm (FBMA), a three-step search (TSS) algorithm and a new three-step search (NTS) algorithm, may be used to calculate a motion vector. A motion vector may have a motion vector value in the unit of a ½ or ¼ pixel on the basis of an interpolated pixel. The motion prediction unit may predict a prediction block of a current block by using different motion prediction methods. Various methods such as a skip method, a merge method and an advanced motion vector prediction (AMVP) method may be used as motion prediction methods.

The subtractor 104 generates a residual block of the current block by subtracting the prediction block generated by the intra prediction unit 102 or the inter prediction unit 103 from the current block to be encoded.

The transform unit 105 may transform the residual block including residual data by using such a transform method as DCT, DST, Karhunen Loeve Transform (KLT) and the like. Herein, the transform method may be determined based on an intra prediction mode of a PU that is used to generate the residual block. For example, according to the intra prediction mode, DCT may be used in the horizontal direction, and DST may be used in the vertical direction. Alternatively, depending on the aspect ratio and size of a current block, different transform techniques may be used in the horizontal direction and in the vertical direction.

The quantization unit 106 may quantize values transformed into a frequency domain by the transform unit 105. A quantization coefficient may change depending on a block or importance of a picture. A value calculated in the quantization unit 106 may be provided to the dequantization unit 108 and the entropy encoding unit 107.

The transform unit 105 and/or the quantization unit 106 may be selectively included in the image encoding apparatus 100. That is, the image encoding apparatus 100 may encode a residual block by performing at least one of a transform and quantization for residual data of the residual block or by skipping both the transform and the quantization. Even when any one of transform and quantization is not performed or both transform and quantization are not performed in the image encoding apparatus 100, a block which is input into the entropy encoding unit 107 is generally referred to as a transform block.

The entropy encoding unit 107 entropy-encodes input data. Various encoding methods, such as exponential Golomb coding, context-adaptive variable length coding (CAVLC), or context-adaptive binary arithmetic coding (CABAC), may be used for entropy encoding.

The entropy encoding unit 107 may encode a variety of information, such as coefficient information of a transform block, block type information, prediction mode information, partitioning unit information, PU information, transfer unit information, motion vector information, reference frame information, block interpolation information and filtering information. Coefficients of a transform block may be encoded in a sub-block unit within the transform block.

For encoding of a coefficient of a transform block, various syntax elements may be encoded such as Last_sig that is a syntax element notifying a position of an initial non-zero coefficient in a reverse scan order, Coded_sub_blk_flag that is a flag notifying whether or not there is at least one non-zero coefficient in a sub-block, Sig_coeff_flag that is a flag notifying whether or not a coefficient is a non-zero coefficient, Abs_greater1_flag that is a flag notifying whether or not the absolute value of a coefficient is greater than 1, Abs_greater2_flag that is a flag notifying whether or not the absolute value of a coefficient is greater than 2, and Sign_flag that is a flag indicating the sign of a coefficient. A residual value of a coefficient, which is not encoded with the syntax elements, may be encoded through a syntax element remaining_coeff.

The dequantization unit 108 and the inverse transform unit 109 dequantize values, which are quantized by the quantization unit 106, and inversely transform values which are transformed by the transform unit 105. A residual value generated by the dequantization unit 108 and the inverse transform unit 109 may be added to a PU, which is predicted through a motion estimation unit, a motion compensation unit, and an intra prediction unit in the prediction units 102 and 103, and thus a reconstructed block may be generated. The adder 110 generates a reconstructed block by adding a prediction block generated by the prediction unit 102 and 103 and a residual block generated through the inverse transform unit 109.

The filter unit 111 may include at least one of a deblocking filter, an offset correction module, and an adaptive loop filter (ALF).

The deblocking filter may remove block distortion generated by a boundary between blocks in a reconstructed picture. In order to determine whether or not to perform deblocking, whether or not to apply the deblocking filter to a current block may be determined based on pixels included in several columns or rows in the block. When the deblocking filter is applied to a block, a strong filter or a weak filter may be applied depending on a required deblocking filtering strength. In addition, when horizontal filtering and vertical filtering are performed in applying the deblocking filter, the horizontal filtering and the vertical filtering may be processed in parallel.

The offset correction unit may correct an offset form an original image in the unit of a pixel on an image for which deblocking is performed. In performing offset correction for a specific picture, it is possible to use a method that distinguishes pixels in an image into a predetermined number of regions, determines a region for which offset is to be performed, and then applies an offset to the region, or a method that applies an offset by considering edge information of each pixel.

The adaptive loop filtering (ALF) may be performed based on a comparison value between a filtered reconstructed image and an original image. Pixels included in an image may be partitioned into predetermined groups, a filter to be applied to each group may be determined, and differential filtering may be performed for each group. Information on whether or not to apply the ALF may be transmitted by each coding unit (CU) in a luma signal, and the shape and coefficient of an ALF to be applied to each block may vary. In addition, an ALF with a same shape (fixed shape) may be applied irrespective of a feature of a block to which the ALF is to be applied.

The memory unit 112 may store a reconstructed block or picture produced through the filter unit 111, and the stored reconstructed block or picture may be provided to the prediction units 102 and 103 when performing inter prediction.

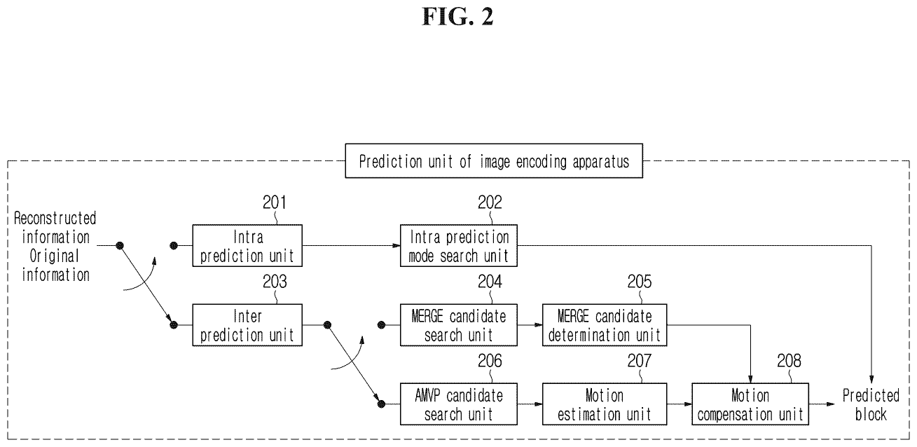

FIG. 2 is a diagram illustrating an embodiment of a prediction unit of an image encoding apparatus.

In case a prediction mode of a current block is an intra prediction mode, an intra prediction unit 201 may generate a reference pixel by deriving the reference pixel from the neighborhood of the current block and filtering the reference pixel. The reference pixel is determined by using a reconstructed pixel around the current block. In case some reconstructed pixels around the current block are unavailable or there is no reconstructed pixel, an available reference pixel may be padded to an unavailable region or padding may be performed using a median value in a range of values that a pixel may have. After every reference pixel is derived, the reference pixel may be filtered using an adaptive intra smoothing (AIS) filter.

An intra prediction mode search unit 202 may determine one mode among M intra prediction modes. Here, M represents a total number of intra prediction modes. The intra prediction modes include a directional prediction mode and a non-directional prediction mode.

A prediction block is generated using a determined prediction mode and a filtered reference pixel. One intra prediction mode with a lowest cost may be selected by comparing RD-costs of intra prediction modes.

The inter prediction unit 203 may be divided into a merge candidate search unit 204 and an AMVP candidate search unit 206 according to a method of deriving motion information. Among reconstructed blocks around a current block, the merge candidate search unit 204 sets a reference block, on which inter prediction is used, as a merge candidate. A merge candidate is derived by a same method in an encoding/decoding apparatus, and a same number of merge candidates is used. The number of merge candidates is transmitted from an encoding apparatus to a decoding apparatus, or a pre-arranged number of merge candidates is used. In case the pre-arranged number of merge candidates are not derived from reconstructed reference blocks around a current block, motion information of a block present in a same position as the current block not in a current picture but in another picture may be used as a merge candidate. Alternatively, from a current picture, motion information in the past direction and motion information in the future direction may be combined to derive a lacking merge candidate. Alternatively, a block of another reference picture in a same position may be set as a merge candidate.

The AMVP candidate search unit 206 determines motion information of a current block in the motion estimation unit 207. The motion estimation unit 207 searches for a most similar prediction block to a current block among reconstructed pictures.

When inter prediction is performed, motion information of a current block is determined using one of the merge candidate search unit 204 and the AMVP candidate search unit 206, and the motion compensation unit 208 generates a prediction block based on the determined motion information.

In hybrid block-based video encoding, a transform plays an important role in energy compression. Transform encoding transforms residual data of a spatial domain to data of a frequency domain to concentrate energy in a low frequency band. As DCT-II, DST-VII and DCT-VIII are linear transforms, an inverse transform for reducing the number of calculations through linearity of transform may be used for video encoding and decoding. When the proposed inverse transform using linearity is applied to video encoding and decoding, run time may be reduced without degradation of coding performance. In particular, an average decoding time may be significantly reduced under the condition of all intra (AI) and random access (RA).

In hybrid block-based video encoding, a residual signal of a spatial domain, which is acquired after intra/inter prediction, is transformed to a residual signal of a frequency domain. Through an efficient transform method, more energy may be concentrated in a low-frequency component of the residual signal in the frequency domain. The Karhunen-Loeve transform (KLT) is a transform method that is efficient in data decorrelation and compression. However, KLT is not used for actual transform coding because KLT has a high degree of complexity in calculating an eigen vector corresponding to a signal-dependent covariance matrix and usually has no fast calculation algorithm.

Many video encoding standards uses DCT-II instead of KLT because DCT-II provides a good approximation to KLT under a first-order Markov condition. However, due to various features of images and videos, DCT-II is not always an optimal transform in terms of energy compression and decorrelation. To solve this problem, DCT-II/DST-VIII and enhanced multiple transform (EMT) for video coding may be used as alternative transform methods.

In addition, when a first-order Gauss-Markov model is used for an image signal, DST-VII may well approach KLT. Accordingly, a video codec may be set to use a transform based on DCT-II for 4×4, 8×8, 16×16 and 32×32 prediction residual blocks and an alternative transform based on DST-VII for 4×4 intra prediction residual blocks.

With the recently increasing demand for high-quality and high-resolution images and the growth of image streaming service, an image compression technology with higher efficiency is being required. A joint separable transform and a non-separable transform may be used to improve the efficiency of transform.

An EMT, which uses a separable attribute of transform, may be selected as a predefined horizontal or vertical transform or a best horizontal or vertical transform in terms of coding efficiency among DCT-II, DCT-V, DCT-VIII, DST-I and DST-II. In addition, a non-separable secondary transform may be applied as a secondary transform following the EMT.

A transform may be divided mainly into two processes: a primary transform and a secondary transform. A simplified EMT, which is applied to a predicted residual signal, may be used by the name of multiple transform selection (MTS). Apart from DCT-II, DST-VII and DCT-VIII may further be used as transform of MTS. However, DST-VII and DCT-VIII may be applied only to a luma block.

A maximum transform size, to which a transform is applied, may be set to 64×64. DCT-II may be applied to a transform of a block with a size of 4×4 to 64×64, and DST-VII and DCT-VIII may be applied to a transform of a block with a size of 4×4 to 32×32.

A transform for a large block is useful for a high-resolution video but may increase computational complexity. To solve this problem, when a large block is transformed, a high-frequency transform coefficient may be processed as 0 (zeroed out). For example, in the case of a 64-point DCT-II transform, first 32 low-frequency coefficients may each be maintained, and the remaining high-frequency coefficients may be processed as 0 (zeroed out). Also, in the case of 32-point DST-VII/DCT-VII, only 16 low-frequency coefficients may be maintained, and the remaining high-frequency coefficients may be processed as 0 (zeroed out). Such zeroning-out may also be considered for last coefficient position coding and coefficient group scanning.

The secondary transform is an additional transform process following the primary transform. According to an embodiment, a low frequency non-separable transform (LFNST) may be used in a video codec. LFNST may be applied to a region of interest (ROI) of a basic transform coefficient. The ROI may be an upper left low frequency region. When LFNST is applied, all the basic transform coefficients but the ROI becomes 0, and an output of LFNST is additionally quantized and entropy-encoded.

A one-dimensional (ID) N-point transform and an inverse transform thereof are defined in Formula 1 and Formula 2 below.

$$\begin{matrix}F ( u ) = {\sum }_{x = 0}^{N - 1} p ( x ) {v}_{u , x} , & u = 0 , 1 , 2 , … , N - 1\end{matrix} \qquad [ Formula 1 ]$$

$$\begin{matrix}p ( x ) = {\sum }_{u = 0}^{N - 1} F ( u ) {v}_{u , x} , & x = 0 , 1 , 2 , … , N - 1\end{matrix} \qquad [ Formula 2 ]$$

Here, F(u) is an N-point transform signal, and p(x) is an original signal. In addition, v_{u,x} is a basic element of a basic vector vᵤ with a N×1 size for each u in DCT-II, DST-VII and DCT-VIII transforms. Here, u,x=(0, 1, 2, . . . , N−1). For DCT-II, DST-VII and DCT-VIII, v_{u,x} is defined as follows in Formula 3, Formula 4 and Formula 5.

$${v}_{u , x} = α ( u ) cos ( \frac{u ( 2 x + 1 ) π}{2 N} ) , α ( u ) = \{ \begin{matrix}\sqrt{1 / N} , & u = 0 \\ \sqrt{2 / N} , & u = 1 , 2 , … , N - 1\end{matrix} \qquad [ Formula 3 ]$$

$${v}_{u , x} = \sqrt{\frac{4}{2 N + 1}} sin ( \frac{( 2 u + 1 ) ( x + 1 ) π}{2 N + 1} ) \qquad [ Formula 4 ]$$

$${v}_{u , x} = \sqrt{\frac{4}{2 N + 1}} cos ( \frac{( 2 u + 1 ) ( x + 1 ) π}{4 N + 2} ) \qquad [ Formula 5 ]$$

The present disclosure provides an inverse transform using separable linearity that is proposed to reduce computational complexity. The proposed inverse transform method may be applied to a basic transform and a basic inverse transform of an encoder and a decoder. At an inverse transform step of the encoder and the decoder, a dequantized transform coefficient after LFNST is input into a two-dimensional (2D) inverse transform. In most video codecs, to reduce computational complexity, a 2D transform and a 2D inverse transform apply the 1D inverse transform of Formula 1 to each row and each column and thus implement the inverse transform as a separable transform. A separable inverse transform for a size of a block, which is not a square, is expressed by Formula 6.

$${X}^{′} = {B}^{T} Y A \qquad [ Formula 6 ]$$

Here, X′ is a (n×m) inverse transform block, Y is a (n×m) dequantized transform block, A is a (m×m) transform block, and B^{T} is a (n×m) transform. Here, n and m are the height and width of a block, respectively. When a quantization coefficient is large through a quantization and dequantization process, most transform coefficients become 0. In case Y is constructed by N non-zero coefficients, Y may be expressed by a sum of Y with only one non-zero coefficient and N sub-blocks with a same size, as shown in Formula 7. Here, yₗ represents an i-th sub-block of Y.

$$Y = {y}_{0} + {y}_{1} + … {y}_{N - 1} \qquad [ Formula 7 ]$$

FIG. 3 provides an example of representing a 4×4 block constructed with 3 non-zero coefficients by a plurality of sub-blocks through Formula 7. According to FIG. 3, a 4×4 block Y 300 includes 3 non-zero coefficients. Accordingly, the 4×4 block Y 300 may be divided into 3 sub-blocks y₀ 302, y₁ 304 and y₂ 306 that include only one non-zero coefficient. Accordingly, a block inverse transform may be performed by inversely transforming the sub-blocks y₀ 302, y₁ 304 and y₂ 306 respectively and by adding results generated by the inverse transform by using linearity of the inverse transform.

DCT-II, DST-VII and DCT-VIII have the following linearity characteristic as shown in Formula 8.

$$T ( α x + β y ) = α T ( x ) + β T ( y ) \qquad [ Formula 8 ]$$

Here, T(*) means a transform, x and y are inputs of the transform, and α and β are any scalar values. By Formula 7 and Formula 8, an inverse transform may be expressed as in Formula 9.

$${X}^{′} = {{\sum }^{N - 1}}_{k = 0} {B}^{T} {y}_{k} A \qquad [ Formula 9 ]$$

If it is assumed that a non-zero transform coefficient is present in the (i, j)-th element of Y, B′yₗA (0≤l≤N−1) may be expressed by Formula 10 using the transform B^{T} and a base vector of A. In Formula 10, yₗ is a matrix where a non-zero transform coefficient is in the (i, j)-th element and a transform coefficient of 0 is in the remaining element.

$${B}^{T} {y}_{l} A = [ \begin{matrix}{v}_{0} & … & {v}_{n - 1}\end{matrix} ] [ \begin{matrix}0 & … & 0 \\ ⋮ & {x}_{i , j} & ⋮ \\ 0 & … & 0\end{matrix} ] [ \begin{matrix}{w}_{0}^{T} \\ ⋮ \\ {w}_{m - 1}^{T}\end{matrix} ] , where {y}_{l} = [ \begin{matrix}0 & … & 0 \\ ⋮ & {x}_{i , j} & ⋮ \\ 0 & … & 0\end{matrix} ] \qquad [ Formula 10 ]$$

x_{i,j} is a non-zero transform coefficient of the (i, j)-th element of a dequantized transform block with a size of (n*m). vᵢ is the i-th base vector of the transform BT, and wᵢ is the i-th base vector of the transform A. When B^{T}yₗ is calculated from Formula 10, Formula 11 is obtained.

$${B}^{T} {y}_{l} = [ \begin{matrix}{v}_{0 , 0} & … & {v}_{n - 1 , 0} \\ ⋮ & ⋱ & ⋮ \\ {v}_{0 , n - 1} & … & {v}_{n - 1 , n - 1}\end{matrix} ] [ \begin{matrix}0 & … & 0 \\ ⋮ & {x}_{i , j} & ⋮ \\ 0 & … & 0\end{matrix} ] = [ \begin{matrix}\begin{matrix}0 & …\end{matrix} & {v}_{i , 0} * {x}_{i , j} & \begin{matrix}… & 0\end{matrix} \\ ⋮ & \begin{matrix}{v}_{i , 1} * {x}_{i , j} \\ ⋮\end{matrix} & ⋮ \\ \begin{matrix}0 & …\end{matrix} & {v}_{i , n - 1} * {x}_{i , j} & \begin{matrix}… & 0\end{matrix}\end{matrix} ] \qquad [ Formula 11 ]$$

$$\begin{matrix}{B}^{T} {y}_{l} A = [ \begin{matrix}\begin{matrix}0 & …\end{matrix} & {v}_{i , 0} * {x}_{i , j} & \begin{matrix}… & 0\end{matrix} \\ ⋮ & \begin{matrix}{v}_{i , 1} * {x}_{i , j} \\ ⋮\end{matrix} & ⋮ \\ \begin{matrix}0 & …\end{matrix} & {v}_{i , n - 1} * {x}_{i , j} & \begin{matrix}… & 0\end{matrix}\end{matrix} ] [ \begin{matrix}{w}_{0 , 0} & … & {w}_{0 , m - 1} \\ ⋮ & ⋱ & ⋮ \\ {w}_{m - 1 , 0} & … & {w}_{m - 1 , m - 1}\end{matrix} ] \\ = [ \begin{matrix}{v}_{i , 0} * {x}_{i , j} * {w}_{j , 0} & … & {v}_{i , 0} * {x}_{i , j} * {w}_{j , m - 1} \\ ⋮ & ⋱ & ⋮ \\ {v}_{i , n - 1} * {x}_{i , j} * {w}_{j , 0} & … & {v}_{i , n - 1} * {x}_{i , j} * {w}_{j , m - 1}\end{matrix} ] \\ = [ \begin{matrix}{v}_{i , 0} * {x}_{i , j} * {w}_{j}^{T} \\ ⋮ \\ {v}_{i , n - 1} * {x}_{i , j} * {w}_{j}^{T}\end{matrix} ]\end{matrix} \qquad [ Formula 12 ]$$

When the proposed (n×m) inverse transform is applied to one non-zero coefficient, the number of multiplications becomes n+(n×m). Accordingly, a total number of multiplications of an inverse transform using linearity for a (n×m) transform block with N non-zero coefficients is calculated as in Formula 13.

$$N \times ( n + ( n \times m ) ) \qquad [ Formula 13 ]$$

Accordingly, only when there is a small number of non-zero coefficients, in order to reduce computational complexity in an inverse transform, a total number of multiplying operations in Formula 13 may be utilized for a fast inverse transform of a dequantized block.

Whether or not to perform an inverse transform by using an existing method with a separable characteristic or the proposed method with separable linearity is determined according to a threshold value that is obtained by comparing the number of multiplying operations of DCT-II, DST-VII and DCT-VIII and Formula 13. The threshold value is calculated beforehand by a maximum number of non-zero coefficients in a dequantized transform block. Herein, in each block size, N×(n+(n×m)) does not exceed the number of multiplying operations of an inverse transform.

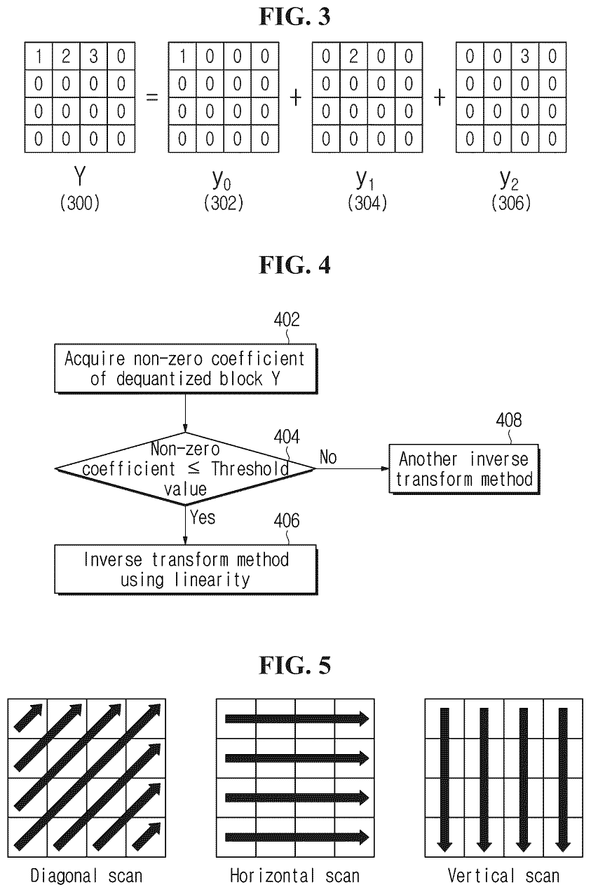

The proposed method is performed as shown in FIG. 4. First, the number of non-zero coefficients of a dequantized transform block Y is counted before an inverse transform process. Second, if the number of the non-zero coefficients does not exceed a threshold value, the proposed inverse transform using separable linearity is performed. Otherwise, another type of inverse transform using odd-even separation is performed as follows.

The transform may be implemented using a fast method or direct matrix multiplication. When direct matrix multiplication is used, the number of multiplications of a 1D N-point transform is N\hat{ }2. DCT-II, DST-VII and DCT-VIII may be implemented using a fast algorithm. In the case of DCT-II, a fast algorithm using symmetry and asymmetry of DCT-II is used. An even-numbered base vector of DCT-II is symmetric, and an odd-numbered base vector of DCT-II is asymmetric. For a N-point input, an even-numbered part and an odd-numbered part are calculated by using sub-set matrices obtained from an even-numbered column and an odd-numbered column of an inverse transform matrix respectively, and then an N-point output is generated by performing adding and subtracting operations between the even-numbered part and the odd-numbered part. This fast method is also referred to as a partial butterfly structure.

Fast DST-VII and DCT-VIII may be used as basic transform solutions. A fast method for DST-VII and DCT-VIII uses a function inherited from DST-VII and DCT-VIII in order to reduce the number of works. DST-VII and DCT-VIII transform matrices have the following functions that are useful for reducing the number of calculations. First, N elements are included while the change of sign is not considered. Second, only a sub-set of N elements is included while the change of sign is not considered. Third, some transform vectors except 0 include only a single element when the change of sign is neglected.

TABLE 1

| | | Width (m) | | | | | | |
|---|---|---|---|---|---|---|---|---|
| | | 1 | 2 | 4 | 8 | 16 | 32 | 64 |
| Height | 1 | N/A | 2 | 8 | 24 | 88 | 344 | 684 |
| (n) | 2 | 2 | 8 | 24 | 64 | 208 | 752 | 1432 |
| | 4 | 8 | 24 | 64 | 160 | 480 | 1632 | 2992 |
| | 8 | 24 | 64 | 160 | 384 | 1088 | 3520 | 6240 |
| | 16 | 88 | 208 | 480 | 1088 | 2816 | 8320 | 13760 |
| | 32 | 344 | 752 | 1632 | 3520 | 8320 | 22016 | 32896 |
| | 64 | 684 | 1496 | 3248 | 7008 | 16576 | 43904 | 65664 |

TABLE 2

Width (m)

| | | 4 | 8 | 16 | 32 |
|---|---|---|---|---|---|
| Height | 4 | 64 | 320 | 636 | 2608 |
| (n) | 8 | 320 | 1024 | 2040 | 5984 |
| | 16 | 636 | 2040 | 4064 | 11952 |
| | 32 | 2736 | 7008 | 13984 | 29760 |

Table 1 shows the number of multiplying operations required for each (n*m) block size when both horizontal and vertical kernels are DCT-II. Table 2 shows the number of multiplying operations required for each n*m block size when horizontal and vertical transforms are a combination of DST-VII and DCT-VIII, that is, (DST-VII, DST-VII), (DST-VII, DCT-VIII), (DCT-VIII, DST-VII) and (DCT-VIII, DCT-VIII).

TABLE 3

Width (m)

| | | 1 | 2 | 4 | 8 | 16 | 32 | 64 |
|---|---|---|---|---|---|---|---|---|
| Height | 1 | N/A | 1 | 2 | 3 | 5 | 10 | 10 |
| (n) | 2 | 1 | 1 | 2 | 3 | 6 | 11 | 11 |
| | 4 | 2 | 2 | 3 | 4 | 7 | 12 | 11 |
| | 8 | 3 | 2 | 4 | 5 | 8 | 13 | 12 |
| | 16 | 5 | 4 | 6 | 7 | 10 | 15 | 13 |
| | 32 | 10 | 7 | 10 | 12 | 15 | 20 | 15 |
| | 64 | 10 | 7 | 10 | 12 | 15 | 20 | 15 |

TABLE 4

Width (m)

| | | 4 | 8 | 16 | 32 |
|---|---|---|---|---|---|
| Height | 4 | 3 | 8 | 9 | 19 |
| (n) | 8 | 8 | 14 | 15 | 22 |
| | 16 | 7 | 14 | 14 | 22 |
| | 32 | 17 | 24 | 25 | 28 |

Table 3 shows a threshold value for the number of non-zero coefficients for each block size of (n*m) when horizontal and vertical kernels are DCT-II/DCT-II or another combination of kernels.

Table 4 shows a threshold value for the number of non-zero coefficients for each block size of (n*m) when horizontal and vertical kernels are combinations of DST-VII and DCT-VIII (DST-VII/DST-VII, DST-VII/DCT-VIII, DCT-VIII/DST-VII, DCT-VIII/DCT-VIII).

The threshold value of each n*m block, which is determined by comparing the number of multiplying operations in Table 1 and Table 2 and the number of multiplying operations that is calculated a priori in Formula 8, is determined by a combination of horizontal and vertical transforms of Table 3 and Table 4. Table 3 shows a threshold value for the number of non-zero coefficients in each n*m block when horizontal and vertical kernels are DCT-II/DCT-II or another combination. Table 4 shows a threshold value representing the number of non-zero coefficients in each n*m block when horizontal and vertical kernels are a combination of DST-VII and DCT-VIII. For example, in case horizontal and vertical transforms are a combination of DST-VII/DCT-VIII and the non-zero coefficient marked in bold type for a 8*8 block of Table 4 is equal to or smaller than 14, an inverse transform may be performed through the proposed inverse transform of the present disclosure.

For a Y component, an average selection ratio of the proposed method may gradually increase along with an increase of QP value. In addition, similar to the Y component, for Cb and Cr components, an average selection ratio of the proposed method may gradually increase along with an increase of QP value. Such a result may be caused by a decrease in the number of non-zero coefficients in a quantization process along with an increase of QP value.

The proposed inverse transform with linearity may be implemented in an encoder and a decoder. As a separable transform according to an embodiment uses a 16-bit precision after vertical and horizontal transform, if the proposed linear transform is applied only to the decoder, there may occur a disagreement between the encoder and the decoder. As the complexity of the decoder is much simpler than that of the encoder, an average decoding time may be reduced more than an encoding time of a random access configuration.

Lastly, when the proposed inverse transform using linearity with separability is applied to the encoder and the decoder, run time may be saved while encoding performance is maintained as compared with application to the decoder.

As described above, in video encoding, a low frequency non-separable transform (LFNST) may be performed a secondary transform. The secondary transform means a transform that is additionally performed after the primary transform. For the secondary transform, primary transformed coefficients expressed in a two-dimensional matrix may be rearranged in a one-dimensional vector. In addition, the secondary transform may be performed according to a direct matrix multiplication of the one-dimensional vector according to the rearrangement and a non-separable kernel.

According to an embodiment, if the one-dimensional vector is separated into sub-vectors with only one non-zero coefficient by using linearity of the transform and the transform is performed by using the direct matrix multiplication for each of the sub-vectors, the number of operations may be reduced in comparison with direct application of the direct matrix multiplication to the one-dimensional vector. Hereinafter, Formula 14 shows a forward secondary transform equation, and Formula 15 shows an inverse secondary transform equation.

$$\begin{matrix}\vec{F} = {T}_{R \times N} \cdot \vec{X} \\ [ \begin{matrix}{T}_{1 , 1} & … & {T}_{1 , N} \\ ⋮ & ⋱ & ⋮ \\ {T}_{R , 1} & … & {T}_{R , N}\end{matrix} ] \cdot [ \begin{matrix}{X}_{1} \\ ⋮ \\ {X}_{N}\end{matrix} ] = [ \begin{matrix}{F}_{1} \\ ⋮ \\ {F}_{R}\end{matrix} ] ,\end{matrix} \qquad [ Formula 14 ]$$

$$\begin{matrix}\vec{X} = {T}_{N \times R}^{t} \cdot \vec{F} \\ [ \begin{matrix}{t}_{1 , 1} & … & {t}_{1 , R} \\ ⋮ & ⋱ & ⋮ \\ {t}_{N , 1} & … & {t}_{N , R}\end{matrix} ] \cdot [ \begin{matrix}{F}_{1} \\ ⋮ \\ {F}_{R}\end{matrix} ] = [ \begin{matrix}{X}_{1} \\ ⋮ \\ {X}_{N}\end{matrix} ]\end{matrix} \qquad [ Formula 15 ]$$

In case the direct matrix multiplication is applied to the one-dimensional vector, the forward transform requires a total of NR multiplications and a total of (N−1) R additions. In addition, the inverse transform requires a total of RN multiplications and a total of (R−1) N additions. In the forward transform, N means a size of an input vector, and R means a size of an output vector. In addition, in the inverse transform, R means a size of an input vector, and N means a size of an output vector.

In case linearity of a transform is used, if there are n non-zero coefficients (forward: 0≤n≤N, inverse: 0≤n≤R) in a one-dimensional vector that is input into the transform, a forward transform requires a total of R×n multiplications and a total of R×(n−1) additions. In addition, an inverse transform requires N×n multiplications and N×(n−1) additions. Accordingly, for a one-dimensional vector with a small number of non-zero coefficients, the operation quantity is significantly reduced by using a transform method that uses linearity of a transform.

Accordingly, not only in the case of a separable transform but also in the case of a non-separable transform, when a transform according to linearity is applied, the operation quantity is also reduced significantly. The non-separable transform method using linearity may be applied to a primary transform as well as to a secondary transform.

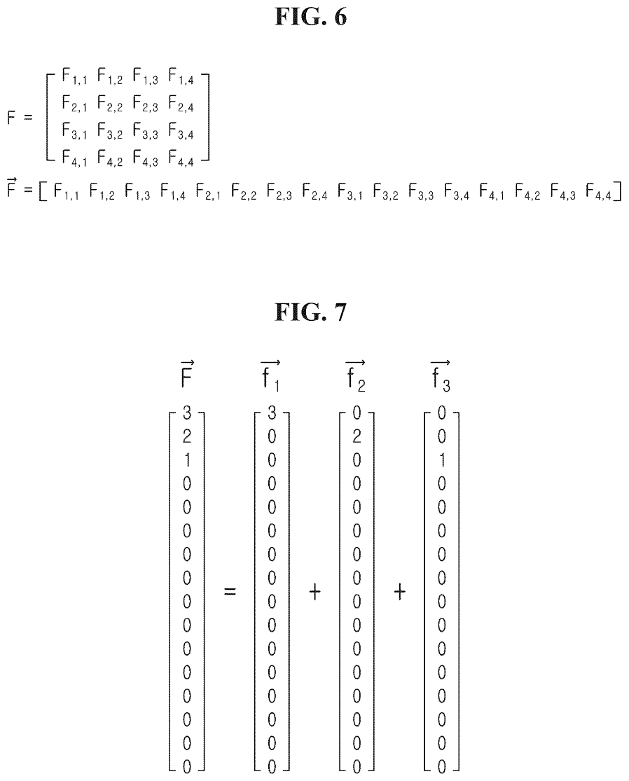

FIG. 5 shows a scan method that rearranges coefficients of a dequantized block into a one-dimensional vector. Coefficients in a dequantized block may be rearranged in a one-dimensional vector according to a block scanning method. From the left side of FIG. 5, diagonal scan, horizontal scan, and vertical scan are introduced. In addition, FIG. 6 shows an example of rearrangement of coefficients in a 4×4 block into a one-dimensional vector using horizontal scan. As described in FIG. 5 and FIG. 6, for two-dimensional non-separable transform, a two-dimensional input matrix is rearranged into a one-dimensional input vector. In addition, the rearranged one-dimensional input vector may be divided into a plurality of sub-vectors including only one non-zero coefficient, each of the plurality of sub-vectors is multiplied by a two-dimensional non-separable kernel, and then results of each multiplication are summed up according to linearity of transform to implement a two-dimensional non-separable transform.

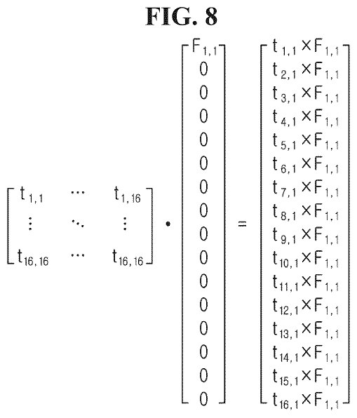

A one-dimensional vector may be divided into sub-vectors having only one non-zero coefficient, and an inverse transform may be performed for each of the sub-vectors. FIG. 7 shows an example of separating a one-dimensional vector into sub-vectors. In addition, FIG. 8 shows an example of performing an inverse transform for each sub-vector.

An ultimate inverse transform vector may be generated by summing up all the vectors as results of an inverse transform for each sub-vector. The ultimate inverse transform vector, which is a one-dimensional vector, may be rearranged into a two-dimensional block according to the block scanning method that is used for the transform.

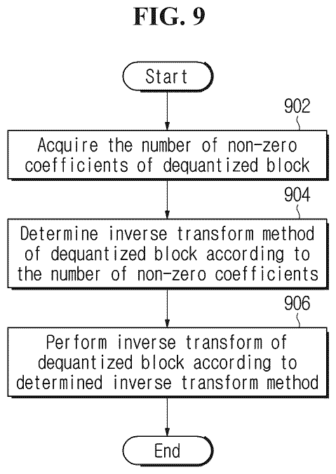

FIG. 9 provides an embodiment of a video decoding method that can use a linear inverse transform method.

At step S902, the number of non-zero coefficients of a dequantized block is acquired.

At step S904, according to the number of the non-zero coefficients, an inverse transform method of the dequantized block is determined.

According to an embodiment, the number of the non-zero coefficients may be compared with a predetermined threshold value, and based on a result of the comparison, the inverse transform method of the dequantized block may be determined.

According to an embodiment, from the number of the non-zero coefficients, the number of multiplying operations required for the linear inverse transform may be determined. In addition, the number of the multiplying operations may be compared with a predetermined threshold value, and based on a result of the comparison, the inverse transform method of the dequantized block may be determined. The number of the multiplying operations may be determined based on the number of the non-zero coefficients and/or a size of the dequantized block.

In the above embodiment, the threshold value may be determined based on the size of the dequantized block.

According to an embodiment, a vertical kernel and a horizontal kernel, which are applied to the dequantized block, may be determined. In addition, the predetermined threshold value may be determined based on the vertical kernel, the horizontal kernel and/or the size of the dequantized block. The vertical kernel and the horizontal kernel may be determined from at least one of a DCT-II transform, a DST-VII transform, and a DCT-VIII transform. In addition, the vertical kernel and the horizontal kernel may be determined based on the size of the dequantized block and a prediction method that is applied to the dequantized block.

According to an embodiment, based on a picture type of the dequantized block, the inverse transform method of the dequantized block may be determined. For example, when a picture type of the dequantized block is an all intra (AI) type or a random access (RA) type, whether or not a linear inverse transform is applied to the dequantized block may be determined according to the number of the non-zero coefficients. On the other hand, when the picture type of the dequantized block is not the AI type or the RA type, it may be determined that the linear inverse transform is not applied to the dequantized block.

According to an embodiment, based on a quantization parameter that is applied to dequantization of the dequantized block, the inverse transform method of the dequantized block may be determined. When the quantization parameter is greater than a threshold quantization parameter value, whether or not the linear inverse transform is applied to the dequantized block may be determined according to the number of the non-zero coefficients. On the other hand, when the quantization parameter is smaller than the threshold quantization parameter value, it may be determined that the linear inverse transform is not applied to the dequantized block.

According to an embodiment, linear inverse transform permission information indicating whether or not the linear inverse transform is permitted may be acquired from a parameter set. In addition, when the linear inverse transform permission information indicates that the linear inverse transform is permitted, it may be determined whether or not the inverse transform method of the dequantized block is a linear inverse transform method. On the other hand, when the linear inverse transform permission information indicates that the linear inverse transform is not permitted, it may be determined that the dequantized block is inverse-transformed by a different inverse transform method than the linear inverse transform method. The parameter set may be at least one of a video parameter set, a sequence parameter set, a picture parameter set, and an adaptation parameter set.

According to an embodiment, based on a color component of the dequantized block, the inverse transform method of the dequantized block may be determined.

At step S906, according to the determined inverse transform method, an inverse transform of the dequantized block is performed. In case the inverse transform method is a linear inverse transform method, the inverse transform of the dequantized block may be performed as follows.

First, the dequantized block may be partitioned into a plurality of sub-blocks that include only one non-zero coefficient and zero coefficients as the remaining coefficients. In addition, for the plurality of sub-blocks, the inverse transform may be performed. Based on each of the plurality of the inverse-transformed element blocks, an inverse transform block of the dequantized block may be acquired.

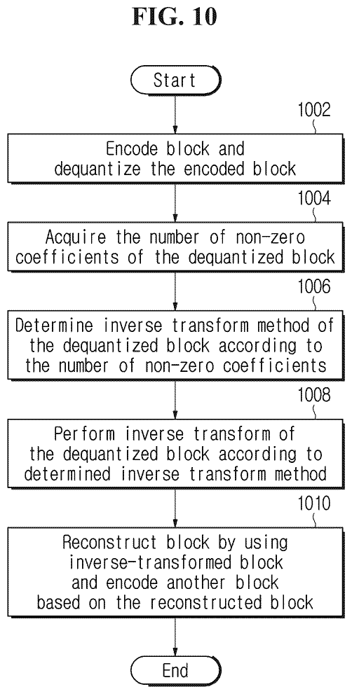

FIG. 10 provides an embodiment of a video encoding method that can use a linear inverse transform method.

In the video encoding method, after blocks of an image are encoded, for encoding of another block of the image or another image, the blocks are decoded and stored in a decoded picture buffer. Accordingly, when a suitable inverse transform method is applied to the video encoding method, the speed of video encoding may be improved. A video encoding method using a linear inverse transform method may be implemented as follows.

At step S1002, a block may be encoded, and the encoded block may be dequantized.

At step S1004, the number of non-zero coefficients of the dequantized block may be acquired.

At step S1006, according to the number of the non-zero coefficients, an inverse transform method of the dequantized block may be determined.

At step S1006, according to the determined inverse transform method, an inverse transform of the dequantized block may be performed.

At step S1004 to step S1008, the configuration of step S902 to step S906 may be applied.

At step S1010, a block may be reconstructed using the inverse-transformed block, and another block may be encoded based on the reconstructed block.

A computer-readable recording medium storing a bitstream generated by the video encoding method of FIG. 10 may be provided. The bitstream generated by the video encoding method of FIG. 10 may be stored in a computer-recordable recording medium. In addition, the bitstream generated by the video encoding method of FIG. 10 may be transmitted from a video encoding apparatus to a video decoding apparatus.

A bitstream for video data stored in a computer-recordable recording medium may be decoded by the video decoding method of FIG. 9. In addition, a bitstream transmitted form the video encoding apparatus to the video decoding apparatus may be decoded by the video decoding method of FIG. 10.

8-Tap DST Interpolation Filter

An existing method applies a 4-tap DCT interpolation filter to every block irrespective of a size of a block. The present disclosure proposes a method of applying an 8-tap DST interpolation filter to 4×4, 4×n and n×4 blocks in order to generate a reference sample for a fractional angle in intra prediction.

A-class sequences with high resolution apply the 8-tap DST interpolation filter to a 4×4 block in place of the 4-tap DCT interpolation filter, and B, C and D-class sequences with relatively low resolution apply the 8-tap DST interpolation filter to a 4×n block and an n×4 block (n=4, 8, 16, 32, 64) in place of the 4-tap DCT interpolation filter.

An 8-tap DST interpolation filer coefficient is derived through DST-VII and inverse DST-VII (IDST-VII), and Table 5 shows coefficients in specific 16/32-pixel positions among 1/32 interpolation filter coefficients.

TABLE 5

| index i | 0 | 1 | 2 | 3 | 4 | 5 | 6 | 7 |
|---|---|---|---|---|---|---|---|---|
| 16/32 pixel | −5 | 12 | −25 | 81 | 81 | −23 | 10 | −3 |
| filter [i] | | | | | | | | |

### Interpolation Filter Analysis

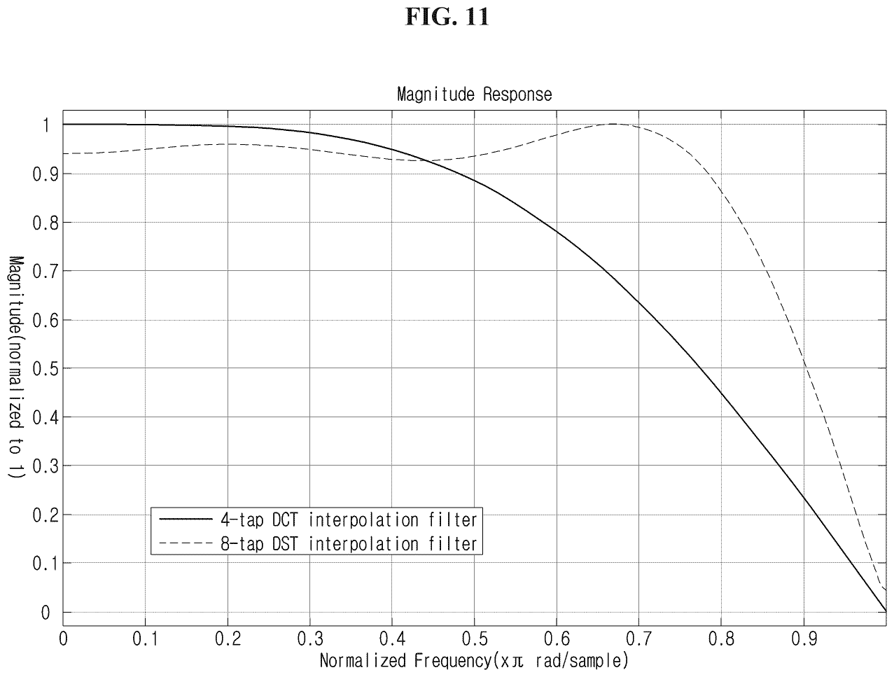

FIG. 11 shows magnitude responses of a 4-tap DCT interpolation filter and an 8-tap DST interpolation filter in a 16/32-pixel position. In FIG. 11, the x axis shows frequency that is normalized to a value between 0 and 1, and the y axis shows magnitude responses.

In FIG. 11, the blue graph shows a magnitude response for the existing 4-tap DCT interpolation filter, and the red graph shows a magnitude response of the 8-tap DST interpolation filter that is the proposed method. As shown in FIG. 11, the two interpolation filters similar low frequency responses, but it can be known that the 8-tap DST interpolation filter has a higher frequency response than the 4-tap DCT interpolation filter.

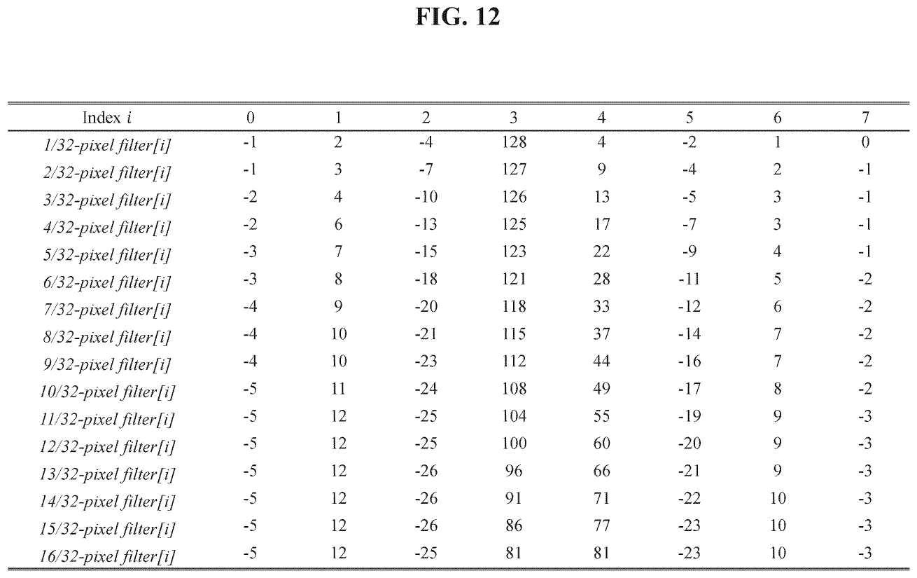

FIG. 12 shows a coefficient of the 8-tap DST interpolation filter.

Formula 16 below shows a method of deriving a coefficient of the 8-tap DST interpolation filter. In Formula 16, Equation (3) is derived by putting Equation (1) into Equation (2).

$$\begin{matrix}[ Formula 16 ] & \\ X ( k ) = \sqrt{\frac{2}{N + \frac{1}{2}}} {\sum }_{n = 0}^{N - 1} x ( n ) sin \frac{( n + 1 ) ( k + \frac{1}{2} ) π}{N + \frac{1}{2}} & ( 1 )\end{matrix}$$

$$x ( n ) = \sqrt{\frac{2}{N + \frac{1}{2}}} {\sum }_{k = 0}^{N - 1} X ( k ) sin \frac{( n + 1 ) ( k + \frac{1}{2} ) π}{N + \frac{1}{2}} \qquad ( 2 )$$

$$x ( n ) = \frac{2}{N + \frac{1}{2}} {\sum }_{m = 0}^{N - 1} x ( m ) {\sum }_{k = 0}^{N - 1} sin \frac{( m + 1 ) ( k + \frac{1}{2} ) π}{N + \frac{1}{2}} sin \frac{( n + 1 ) ( k + \frac{1}{2} ) π}{N + \frac{1}{2}} \qquad ( 3 )$$

The present disclosure proposes that an 8-tap DCT interpolation filter is used for a block with an nTbs of 2 in place of an existing 4-tap DCT interpolation filter and an 8-tap Gaussian interpolation filter is used for a block with an nTbS of 5 or more in place of an existing 4-tap Gaussian interpolation filter.

Table 6 shows coefficients in specific 16/32-pixel positions among 1/32 pixel 8-tap DCT interpolation filter coefficients. Table 7 shows coefficients in specific 16/32-pixel positions among 1/32 pixel 8-tap Gaussian interpolation filter coefficients.

TABLE 6

| index i | 0 | 1 | 2 | 3 | 4 | 5 | 6 | 7 |
|---|---|---|---|---|---|---|---|---|
| 16/32 pixel | −3 | 11 | −24 | 80 | 80 | −24 | 11 | −3 |
| filter [i] | | | | | | | | |

TABLE 7

| index i | 0 | 1 | 2 | 3 | 4 | 5 | 6 | 7 |
|---|---|---|---|---|---|---|---|---|
| 16/32 pixel | 2 | 14 | 42 | 70 | 70 | 42 | 14 | 2 |
| filter [i] | | | | | | | | |

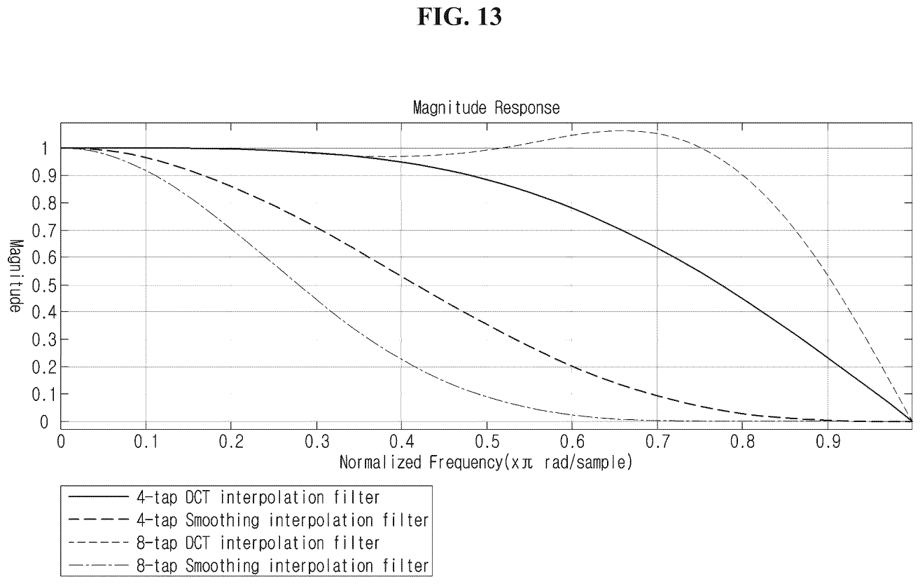

FIG. 13 shows magnitude responses of a 4-tap DCT interpolation filter, a 4-tap Gaussian interpolation filter, an 8-tap DCT interpolation filter, and an 8-tap Gaussian interpolation filter in a 16/32-pixel position. The x axis shows frequency that is normalized to a value between 0 and 1, and the y axis shows magnitude responses.

From the comparison between the blue graph, which is a 4-tap DCT interpolation filter, and the yellow graph that is an 8-tap DCT interpolation filter, it may be known that the 8-tap DCT interpolation filter has a higher frequency response than the 4-tap DCT interpolation filter. In addition, from the comparison between the red graph, which is a 4-tap Gaussian interpolation filter, and the purple graph that is an 8-tap Gaussian interpolation filter, it may be known that the 8-tap Gaussian interpolation filter has a lower frequency response than the 4-tap Gaussian interpolation filter.

In the present disclosure, in intra prediction, besides the 4-tap DCT interpolation filter and the 4-tap Gaussian interpolation filter that are used to generate a reference sample, the 8-tap DCT interpolation filter and the 8-tap Gaussian interpolation filter are additionally used according to a block size and a directional mode, so that performance is improved. In the present disclosure, 8-tap interpolation filters (4×4, 4×8, 8×4, etc.) may be applied to a block with an nTbS of 2, and Gaussian 8-tap interpolation filters (32×32, 32×64, 64×32, 64×64) may be applied to a block with an nTbS of 5 or more.

### Frequency-Based Adaptive Interpolation Filter in Intra Prediction

In VVC intra prediction, an 8-tap discrete cosine transform-based interpolation filter (DCT-IF) and an 8-tap smoothing interpolation filter (SIF) using more reference samples are applied replacing an existing 4-tap DCT-IF and an existing 4-tap SIF. As the 8-tap DCT-IF has a higher frequency than the 4-tap DCT-IF and the 8-tap SIF has a lower frequency than the 4-tap SIF, an 8-tap interpolation filter type is selected and used according to a feature of a block.

The feature of a block is determined using a size of the block and a frequency of a reference sample, and the type of an interpolation filter used for the block is selected.

As the size of a block is smaller, a correlation is lower and more high frequencies exist, and as the size is larger, the correlation is higher and more low frequencies exist, and this characteristic is used.

A frequency of a reference sample may be acquired by applying a transform to a reference sample of a block through DCT-II. According to an intra prediction mode, an upper reference sample is used in a vertical direction, and a left-side reference sample is used in a horizontal direction. As a frequency energy percentage is higher, a block has a higher frequency characteristic.

A frequency characteristic of a block is determined by comparing a high frequency energy percentage and a threshold according to a block size, and an interpolation filter to be applied to a block is selected.

According to frequency information, an 8-tap DCT-IF, which is a strong high pass filter (HPF), is applied to a block with many high frequencies, and an 8-tap SIF, which is a strong low pass filter (LPF), is applied to a block with many low frequencies.

When a size of a block is small, the 8-tap DCT-IF, which is a strong HPF, is applied by using a characteristic of lower correlation along with a smaller block size and a method of applying a strong HPF to a block with many high frequencies according to frequency information. The 4-tap SIF, which is a weak LPF, is used when there is a small number of high frequencies.

When a size of a block is large, the 8-tap SIF, which is a strong LPF, is applied by using a characteristic of higher correlation along with a larger block size and a method of applying a strong LPF to a block with many low frequencies according to frequency information. The 4-tap DCT-IF, which is a weak HPF, is used when there is a large number of high frequencies.

### Example of Obtaining a High Frequency Energy Percentage

In case an intra mode is a horizontal direction, N is a height of a block, and in case it is a vertical direction, N is a width of a block. When using a smaller number of reference samples or a larger number of reference samples, the value of N may be smaller or larger. X means a reference sample. In this case, a high frequency region uses a reference sample with a length of ¼ N, and the length of this region may be decreased or increased when high frequency energy is obtained using less reference samples or more reference samples. Formula 17 shows a method of obtaining a ratio of high frequency energy.

$$high\_freq \_ratio = \frac{{\sum }_{k = N * 3 / 4}^{N - 1} X [ k ] * X [ k ]}{{\sum }_{k = 0}^{N - 1} X [ k ] * X [ k ]} * 100 \qquad [ Formula 17 ]$$

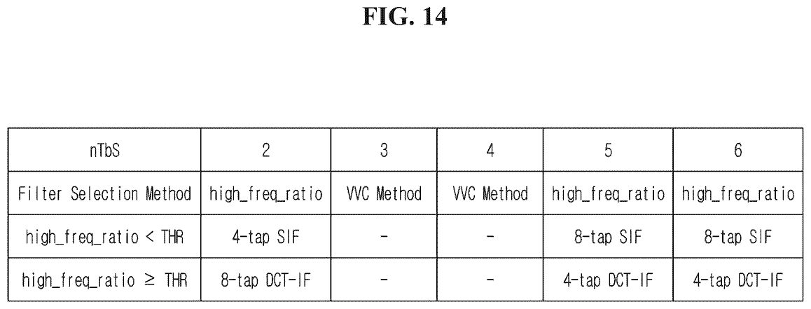

FIG. 14 shows an example of a method for selecting an interpolation filter by using frequency information.

In case a high frequency energy percentage of a block with an nTbS of 2 is smaller than a threshold, a 4-tap SIF is applied, and otherwise, an 8-tap DCT-IF is applied. In case a high frequency energy percentage of a block with an nTbS of 5 or greater is smaller than a threshold, an 8-tap SIF is applied, and otherwise, a 4-tap DCT-IF is applied.

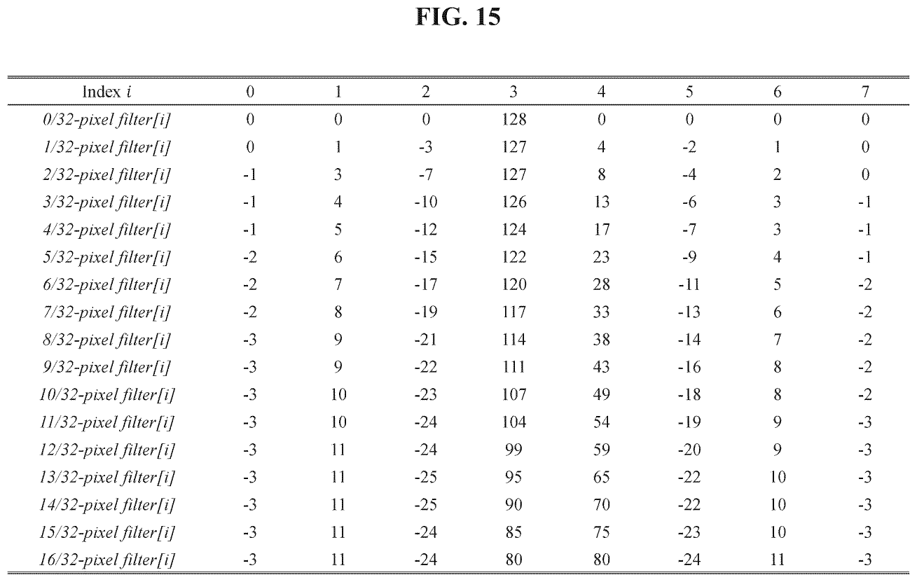

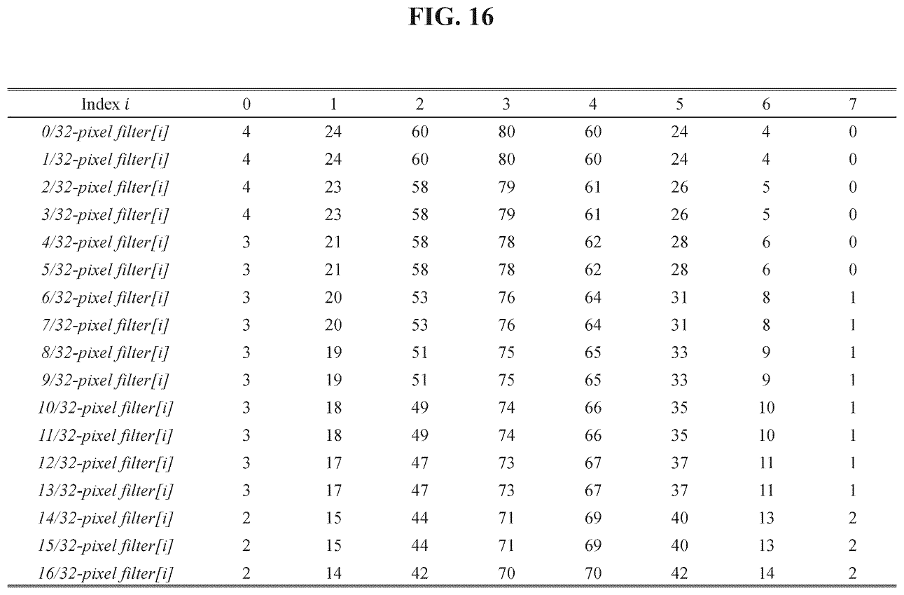

FIG. 15 and FIG. 16 each show a coefficient of an 8-tap DCT interpolation filter and an 8-tap smoothing interpolation filter.

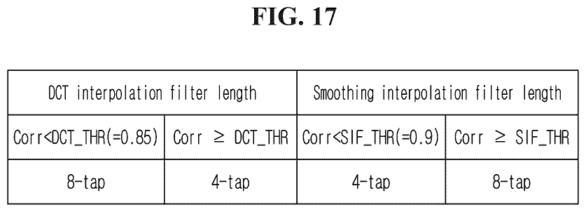

In the present disclosure, coding efficiency may be improved by calculating a threshold value based on a correlation, high_freq_ratio and a block size (nTbS) for each image. Performance ma be improved only by using length selection of a filter only as a boundary correlation threshold for every block size. A correlation threshold may be independently applied to a long/short tap DCT-IF and an SIF, and the correlation threshold may also be applied together with high_freq_ratio. FIG. 17 shows an embodiment of an interpolation filter that is selected according to a boundary correlation threshold.

The various embodiments of the present disclosure are not intended to list all possible combinations but to illustrate representative aspects of the present disclosure. The matters described in the various embodiments may be applied independently or in a combination of two or more.

Also, the various embodiments of the present disclosure may be implemented by hardware, firmware, software, or a combination thereof. With hardware implementation, the embodiment may be implemented by using at least one or more of a group of application specific integrated circuits (ASICs), digital signal processors (DSPs), digital signal processing devices (DSPDs), programmable logic devices (PLDs), field programmable gate arrays (FPGAs), general-purpose processors, controllers, micro controllers, and micro processors.

The scope of the present disclosure includes software or machine-executable instructions (for example, an operating system, an application, firmware, a program, etc.), which cause an operation according to the methods of the various embodiments to be performed on a device or a computer, and includes a non-transitory computer-readable medium storing such software or instructions to execute on a device or a computer.

1. A video decoding method comprising:
acquiring the number of non-zero coefficients of a dequantized block;
determining an inverse transform method of the dequantized block according to the number of non-zero coefficients; and
performing an inverse transform of the dequantized block according to the determined inverse transform method.

2. The video decoding method of claim 1, wherein the determining of the inverse transform method of the dequantized block comprises:
comparing the number of the non-zero coefficients and a predetermined threshold value; and
determining the inverse transform method of the dequantized block based on a result of the comparison.

3. The video decoding method of claim 1, wherein the determining of the inverse transform method of the dequantized block comprises:
determining the number of multiplying operations required for a linear inverse transform from the number of the non-zero coefficients;
comparing the number of the multiplying operations and a predetermined threshold value; and
determining the inverse transform method of the dequantized block based on a result of the comparison.

4. The video decoding method of claim 3, wherein the number of the multiplying operations is determined based on the number of the non-zero coefficients and a size of the dequantized block.

5. The video decoding method of any one of claim 2 and claim 3, wherein the predetermined threshold value is determined based on the size of the dequantized block.

6. The video decoding method of any one of claim 2 and claim 3, further comprising determining a vertical kernel and a horizontal kernel that are applied to the dequantized block,
wherein the predetermined threshold value is determined based on the vertical kernel, the horizontal kernel and the size of the dequantized block.

7. The video decoding method of claim 6, wherein the vertical kernel and the horizontal kernel are determined from at least one of a DCT-II transform, a DST-VII transform and a DCT-VIII transform.

8. The video decoding method of claim 6, wherein the vertical kernel and the horizontal kernel are determined based on the size of the dequantized block and a prediction method that is applied to the dequantized block.

9. The video decoding method of claim 1, wherein based on a picture type of the dequantized block, the inverse transform method of the dequantized block is determined.

10. The video decoding method of claim 9, wherein the determining of the inverse transform method of the dequantized block comprises determining, according to the number of the non-zero coefficients, whether or not a linear inverse transform is applied to the dequantized block, when the picture type of the dequantized block is an all intra (AI) type or a random access (RA) type.

11. The video decoding method of claim 9, wherein the determining of the inverse transform method of the dequantized block determines that the linear inverse transform is not applied to the dequantized block, when the picture type of the dequantized block is not the AI type or the RA type.

12. The video decoding method of claim 1, wherein based on a quantization parameter that is applied to dequantization of the dequantized block, the inverse transform method of the dequantized block is determined.

13. The video decoding method of claim 12, comprising determining whether or not a linear inverse transform is applied to the dequantized block, according to the number of the non-zero coefficients, when the quantization parameter is greater than a threshold quantization parameter value.

14. The video decoding method of claim 12, wherein, when the quantization parameter is smaller than the threshold quantization parameter value, the linear inverse transform is determined not to be applied to the dequantized block.

15. The video decoding method of claim 1, further comprising acquiring, from a parameter set, linear inverse transform permission information indicating whether or not a linear inverse transform is permitted,
wherein the determining of the inverse transform method of the dequantized block determines whether or not the inverse transform method of the dequantized block is a linear inverse transform method, when the linear inverse transform permission information indicates that the linear inverse transform is permitted.

16. The video decoding method of claim 15, wherein the parameter set is at least one of a video parameter set, a sequence parameter set, a picture parameter set, and an adaptation parameter set.

17. The video decoding method of claim 1, wherein based on a color component of the dequantized block, the inverse transform method of the dequantized block is determined.

18. The video decoding method of claim 1, wherein, according to the determined inverse transform method, the performing of the inverse transform of the dequantized block comprises:
when the inverse transform method is a linear inverse transform method, partitioning the dequantized block into a plurality of sub-blocks that include only one non-zero coefficient and a remaining coefficient as a zero coefficient;
performing an inverse transform for each of the plurality of sub-blocks; and
acquiring an inverse-transformed block of the dequantized block based on each of a plurality of inverse-transformed element blocks.

19. A video encoding method comprising:
encoding a block and dequantizing the encoded block;
acquiring the number of non-zero coefficients of the dequantized block;
determining an inverse transform method of the dequantized block according to the number of non-zero coefficients;
performing an inverse transform of the dequantized block according to the determined inverse transform method; and
reconstructing a block by using the dequantized block and encoding another block based on the reconstructed block.

20. A computer-readable recording medium storing a bitstream for an encoded video, the computer-readable recording medium comprising the bitstream that is generated by a video encoding method,
wherein the method comprises:
encoding a block and dequantizing the encoded block;
acquiring the number of non-zero coefficients of the dequantized block;
determining an inverse transform method of the dequantized block according to the number of non-zero coefficients;
performing an inverse transform of the dequantized block according to the determined inverse transform method; and
reconstructing a block by using the dequantized block and encoding another block based on the reconstructed block.
